(19) United States
(12) Patent Application Publication
(10) Pub. No.: US 2026/0299998 A1
(43) Pub. Date: Oct. 1, 2026

(54) WORKGROUP DISPATCH FOR CONFIGURABLE COMPUTE CLUSTERS

(71) Applicant: ADVANCED MICRO DEVICES, INC., Santa Clara, CA (US)

(72) Inventors: Alexander Fuad Ashkar, Winter Park, FL (US); Manu Rastogi, Casselberry, FL (US); Rakan Khraisha, Orlando, FL (US)

(21) Appl. No.: 19/089,426

(22) Filed: Mar. 25, 2025

(51) Int. Cl. G06F 9/48

(52) U.S. Cl. CPC G06F 9/4881

(57) ABSTRACT

A processing system having a configurable number of compute clusters dispatches workgroups to different compute clusters. Based on the number of compute clusters configured for the processing system, dispatch controllers of the processing system select segments of a thread grid, and dispatch the thread groups indicated by the selected segments to the different compute clusters. By selecting the segments based on the number of configured compute clusters, the dispatch controllers are able to omit review of grid segments targeted to other compute clusters, and are thus able to dispatch selected segments in consecutive processing cycles.

### BACKGROUND

To execute applications, some processing systems include multiple processing devices such as central processing units (CPUs), graphics processing units (GPUs), and the like that execute instructions, perform operations, or both on behalf of these applications. Many of these processing devices include one or more dies that have processing elements (e.g., processor cores, compute units, and the like) configured to execute the instructions. These dies are disposed on a silicon interposer configured to connect the processing elements on the dies to other components of a processing system such as a host device or memory. To enhance processing efficiency, some processing systems employ parallel execution techniques, including distributing workloads among the different processing elements for concurrent execution. For example, some processing systems dispatch different sets of threads (referred to as workgroups) to different processing elements of the system, and the processing elements execute the respective workgroups in parallel. However, conventional approaches to dispatching the workgroups are inefficient, negatively impacting overall efficiency of the processing systems.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that dispatches workgroups based on a number of configured compute clusters of the system in accordance with some embodiments.

FIG. 2 is a block diagram of a thread grid employed by the processing system of FIG. 1 in accordance with some embodiments.

FIG. 3 is a block diagram illustrating an example of dispatch controllers of the processing system of FIG. 1 selecting segments of a thread grid for dispatch to corresponding compute clusters in accordance with some embodiments.

FIG. 4 is a block diagram illustrating a different configuration of the processing system of FIG. 1 with a different number of compute clusters in accordance with some embodiments.

FIG. 5 is a block diagram illustrating an example of dispatch controllers of the processing system of FIG. 4 selecting segments of a thread grid for dispatch to corresponding compute clusters in accordance with some embodiments.

FIG. 6 is a block diagram illustrating an example dispatch controller of the processing system of FIG. 1 in accordance with some embodiments.

FIG. 7 is a flow diagram illustrating a method of selecting workgroups for dispatch from a thread grid based on a number of configured compute clusters of a processing system in accordance with some embodiments.

### DETAILED DESCRIPTION

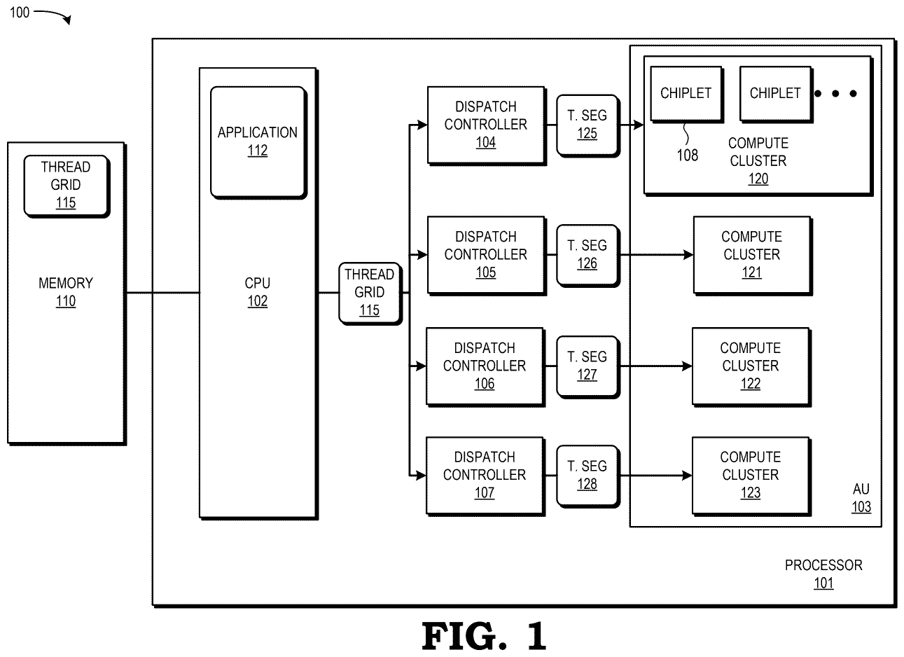

FIGS. 1-7 illustrate techniques for dispatching workgroups to different compute clusters of a processing system having a configurable number of compute clusters. Based on the number of compute clusters configured for the processing system, dispatch controllers of the processing system select segments of a thread grid, and dispatch the thread groups indicated by the selected segments to the different compute clusters. By selecting the segments based on the number of configured compute clusters, the dispatch controllers are able to omit review of grid segments targeted to other compute clusters, and are thus able to dispatch selected segments in consecutive processing cycles, thereby enhancing overall processing efficiency.

To illustrate, some processing systems employ a modular design wherein different processing devices (e.g., chiplets) are configured, based on programmable configuration information, to form compute clusters that together perform as a more capable processing unit than the individual processing devices. Thus, for example, some processing systems employ graphics processing unit (GPU) chiplets, wherein each GPU chiplet includes resources of a GPU (e.g. compute units, cache memory, and the like). The processing systems configure the different GPU chiplets, and the different semiconductor dies containing the GPU chiplets, to form different compute clusters, wherein the compute clusters include resources to execute GPU operations. Furthermore, the processing system is able to configured the different compute clusters to work cooperatively to execute the GPU operations, such that the compute clusters together form, from the perspective of executing software, a complete GPU.

To facilitate the cooperative execution of the graphics operations at the different compute clusters, a processing system includes multiple dispatch controllers, with each compute cluster assigned an individual dispatch controller. Each dispatch controller receives from a central processing unit (CPU) a thread grid, identifying the program threads to be distributed among the different compute clusters. The thread grid is a multi-dimensional (e.g., three-dimensional) data structure, wherein the workgroup designated for a particular compute cluster repeats regularly along the different dimensions of the thread grid. For example, for a processing system having four compute clusters, the segments to be dispatched to a given compute cluster occur every four entries in the thread grid along the x-axis. Conventionally, a dispatch controller selects the segments of the thread grid to be dispatched to the corresponding compute cluster by performing a grid walk, wherein the controller proceeds segment by segment through the grid, selecting only those segments assigned to the corresponding compute cluster. However, this limits the overall dispatch throughput, because during some processor cycles the dispatch controllers are walking over segments not targeted to the corresponding compute cluster (and therefore are not dispatching segments of the thread grid curing these processor cycles).

Disclosed herein are techniques for improving the efficiency of dispatching segments of the thread grid to the compute clusters. In some implementations, the dispatch controllers of a processor selects a segment of the thread grid by skipping, after each dispatch, a number of segments in the thread grid over one or more of the grid axes (e.g., the X-axis of the thread grid), and dispatching the selected segment during the next processor cycle. The number of segments skipped by the dispatch controllers is based on a programmable segment size that indicates the number of compute clusters employed by the processor. By skipping over the thread grid segments, rather than walking over each segment of the thread grid, the dispatch controllers increase throughput and thereby improve overall processing efficiency at the processor. In addition, because the number of skipped segments is programmable, the processor efficiently dispatches thread grid segments under different processor configurations, such as configurations having different numbers of compute clusters.

FIG. 1 illustrates a processing system 100 in accordance with some implementations. The processing system 100 is generally configured to execute sets of instructions (e.g., computer programs) to carry out operations on behalf of an electronic device. Accordingly, in different implementations, the processing system 100 is part of one of a number of electronic devices, such as a desktop computer, laptop computer, server, smartphone, game console, tablet, and the like. To facilitate execution of the sets of instructions, the processing system 100 includes a processor 101 and a memory 110. As described further below, the processor 101 includes configurable processor resources, including one or more processing units that together execute the sets of instructions by executing operations specified by those sets of instructions. The memory 110 is volatile memory (e.g., dynamic random access memory (DRAM)), non-volatile memory, or a combination thereof, that is generally configured to store and retrieve data based on memory access operations generated by the processor 101.

According to implementations, processing system 100 is configured to execute one or more applications (e.g., application 112). Such applications, for example, include compute applications, graphics applications, machine-learning applications, neural network applications, artificial intelligence applications, high-performance computing (HPC) applications, or any combination thereof, to name a few. In some implementations, certain applications (e.g., compute applications, machine-learning applications, neural-network applications, artificial intelligence applications, HPC applications), when executed by processing system 100, causes processing system 100 to perform one or more computations, for example, machine-learning computations, neural network computations, databasing computations, sequencing computations, modeling computations, forecasting computations, or the like. Further, graphics applications, when executed by processing system 100, causes processing system 100 to render a scene including one or more graphics objects within a screen space and, for example, display them on a display device (not shown).

To help execute one or more applications 112, processing system 100 includes a central processing unit (CPU) 102 and one or more accelerator units (AUs) (e.g., AU 103) each having a modular architecture. The CPU 102 includes one or more processor cores (not shown), wherein each processor core includes one or more instruction pipelines to fetch application instructions, decode the fetched instructions into one or more operations, dispatch the operations to one or more execution units, and retire the instructions upon completion of the associated operations. In the course of executing the instructions, the processor cores generate work items (e.g., commands) for execution by the one or more AUs, such as AU 103.

The AU 103, for example, is configured to operate as one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., FPGAs), or any combination thereof. In implementations, the AU 103 performs one or more commands, instructions, draw calls, or any combination thereof indicated in an application 112. For example, for certain applications such as compute applications, machine-learning applications, neural network applications, artificial intelligence applications, HPC applications, and the like, the AU 103 performs one or more commands, instructions, draw calls, or any combination thereof so as to generate one or more results for one or more computations (e.g., machine-learning computations, neural network computations, databasing computations, sequencing computations, modeling computations, forecasting computations). As another example, for graphics applications, the AU 103 performs one or more commands, instructions, draw calls, or any combination thereof so as to render images according to one or more graphics applications for presentation on a display device. To this end, AU 103 renders graphics objects (e.g., groups of primitives) to produce values of pixels that are provided to the display device which uses the pixel values to display an image that represents the rendered graphics objects. Though the example implementation illustrated in FIG. 1 presents processing system 100 as including one AU 103, in other implementations, processing system 100 includes any number of AUs.

To help perform commands, instructions, draw calls, or any combination thereof for one or more application 112, each AU, including AU 103, includes a modular architecture that includes one or more compute clusters (e.g., compute clusters 120-123 and associated connection circuitry (not shown). The connection circuitry, for example, includes one or more dies, data fabrics, busses, ports, traces, interleavers, or any combination thereof configured to connect one or more elements (e.g., memory stacks) of AU 103 to one or more other elements.

According to implementations, each compute cluster of AU 103 also includes one or more one or more compute dies. A compute die, for example, includes a die having one or more processor cores, compute units, caches, or any combination thereof. For example, a compute die includes a die having one or more chiplets (e.g., chiplet 108) disposed thereon that include one or more processor cores operating as compute units and one or more caches communicatively coupled to the processor cores. Each compute unit, for example, is configured to perform one or more operations for one or more applications 112 being executed by processing system 100. For example, the compute units of a chiplet are configured to execute operations for applications 112 concurrently or in parallel. In some implementations, one or more compute units include single instruction multiple data (SIMD) units that perform the same operation on different data sets. As an example, one or more compute cores include SIMD units that perform the same operation as indicated by one or more commands, instructions, or both from an application 112. According to implementations, after performing one or more operations for an application 112, a SIMD unit stores the data resulting from the performance of the operation (e.g., the results) in a cache of the compute die, memory 110, a memory stack, or any combination thereof.

According to implementations, compute cluster (CC) includes a die having one or more core chiplets that include one or more pairs of processor cores operating as one or more compute units and one or more caches. As an example, a CC includes a number of processor cores each operating as compute units that are communicatively coupled to each other by one or more caches. Each CC includes a die having one or more chiplets (e.g., accelerated complexes (ACs)) each including one or more compute units (e.g., hardware-based compute units) and one or more accelerators. Such accelerators include, for example, hardware-based accelerators, FPGA-based accelerations, asynchronous compute circuitry, or any combination thereof to name a few. Such asynchronous compute circuitry, for example, is configured to assign operations, tasks, or both to compute units so as to allow for order-independent execution. For example, asynchronous compute circuitry is configured to assign operations to the compute units of an AC such that the compute units of the AC call a routine, task, operation, or any combination thereof in a pipeline before one or more preceding routines, tasks, or operations (e.g., routines, tasks, operations coming before the called routine, task, or operation in the pipeline) are returned.

Processing system 100, in some implementations, is configured to partition one or more resources (e.g., compute dies, memory stacks, compute clusters, dispatch controllers) of the AU 103 into one or more partitions. For example, processing system 100 is configured to partition the resources of the AU 103 into one or more partitions and then assign each partition to a respective application being executed by processing system 100. As an example, and as further described below with respect to FIG. 3 in some implementations, processing system 100 is configured to partition the compute clusters into partitions of two sets of compute clusters and then assign each partition of compute clusters to a corresponding application being executed. In some implementations, to partition resources of the AU 103, processing system 100 includes a hypervisor (not pictured for clarity) configured to edit one or more registers of the AU 103 so as to partition the compute clusters. In the illustrated example, the AU 103 is set as a single partition, so that all of the compute clusters 120-123 are assigned to the application 112.

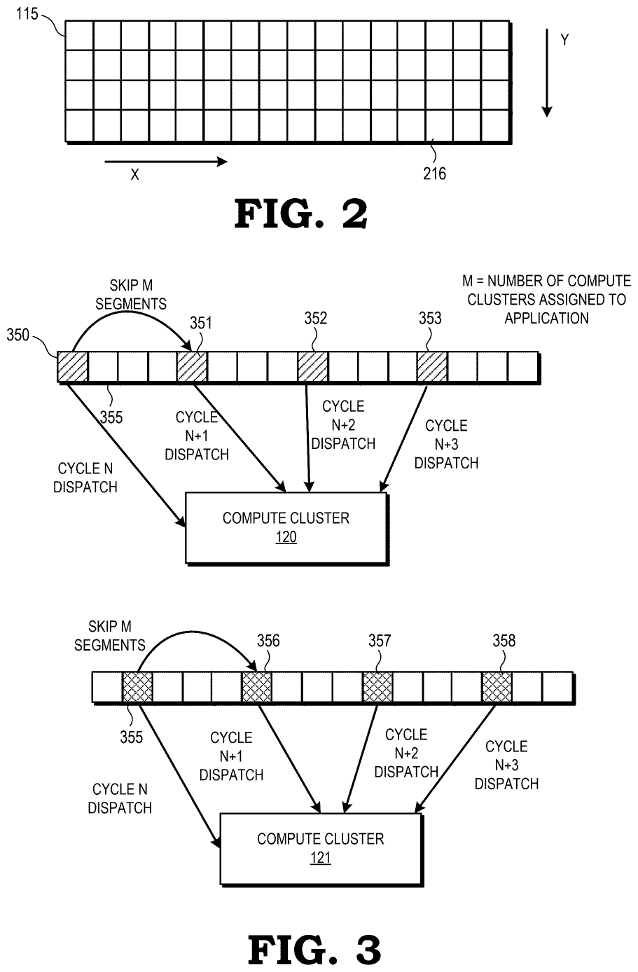

In implementations, the application 112 distributes work to the compute clusters 120-123 by generating a thread grid 115. In particular, the thread grid 115 is a multi-dimensional grid including a plurality of segments, wherein each segment identifies one or more threads, and each thread includes a set of operations to be executed by the compute units of a compute cluster. An example of the thread grid 115 is illustrated at FIG. 2 in accordance with some implementations. In the example illustrated at FIG. 2, the thread grid 115 is a two-dimensional thread grid having an X dimension and a Y dimension. The thread grid 115 includes a plurality of segments (e.g., segment 216) arranged along the two axes. Each segment identifies a number of threads, and in some implementations the number of threads indicated by a segment is programmable, such as by the application 112 writing a value to a specified register (not shown). It will be appreciated that FIG. 2 illustrates a two-dimensional thread grid for clarity, but that in other implementations the thread grid 115 includes more than two dimensions. For example, in some implementations the thread grid 115 is a three-dimensional grid having segments further arranged along a Z dimension.

Returning to FIG. 1, to support the distribution of thread segments (sometimes referred to herein simply as segments) of the thread grid 115, the processor 101 includes a plurality of dispatch controllers, designated dispatch controllers 104-107. Each of the dispatch controllers 104-107 is circuitry configured to select segments of the thread grid 115 and to provide the selected thread segments to a corresponding one of the compute clusters 120-123 for execution. Thus, in the illustrated implementation, the dispatch controller 104 selects thread segments 125 from the thread grid 115 and provides the thread segments 125 to the compute cluster 120. Similarly, the dispatch controller 105 selects thread segments 126 from the thread grid 115 and provides the thread segments 126 to the compute cluster 120, the dispatch controller 106 selects thread segments 127 from the thread grid 115 and provides the thread segments 127 to the compute cluster 122, and the dispatch controller 107 selects thread segments 128 from the thread grid 115 and provides the thread segments 128 to the compute cluster 123. In some implementations, each of the compute clusters 120-123 includes a scheduler (e.g., a shader processor input (SPI) circuit) that is configured to schedule the threads of the provided thread segments to the compute units of the respective compute cluster. Thus, for example, the compute cluster 120 includes a scheduler (not shown) configured to distribute the threads indicated by thread segments 125 among the compute units of the compute cluster 120.

To select the thread segments for the corresponding compute cluster, each of the dispatch controllers 104-107 performs a process referred to as a grid walk. Conventionally, to perform a grid walk each dispatch controller reviews each segment of the thread grid, and selects only those segments that are indicated (e.g., by an identifier included in the segment) as being targeted for the corresponding compute cluster. However, this approach requires each dispatch controller to consume processor cycles reviewing segments that are not targeted for the corresponding compute cluster. As used herein, a processor cycle refers to a number of clock cycles (e.g., one clock cycle) of a clock (not shown) that governs the operations of the dispatch controller. The processor cycles consumed by a dispatch controller to walk over (that is, review and not select) thread segments targeted for other compute clusters (that is compute clusters not assigned to the dispatch controller) reduces overall thread throughput at an AU.

Accordingly, to increase throughput, in some implementations the dispatch controllers 104-107 execute a thread selection scheme wherein each display controller skips, along at least one axis of the thread grid 115, a number of segments between selected segments, such that the skipped segments are not reviewed by the dispatch controller, and the segments selected along the one or more axes are issued by the dispatch controller in successive processor cycles. The number of segments skipped by each dispatch controller is based on the number of compute clusters assigned to the application that generated the thread grid. Thus, the dispatch controllers 104-107 adapt the thread segment selection according to the number of compute clusters assigned to an application, and thereby increase dispatch throughput under a variety of different configurations of the processor 101.

In some implementations, the dispatch controllers 104-107 select the corresponding thread segments 125-128, from the thread grid 115, according to the following pseudo code:
pre_computed_skip_segment=(num_clusters-1)*segment_size
x, y, z=thread group id at end of current segment;
@end of walking valid segment:
if (x+pre_computed_skip_segment<xdim):
   skip_walk=true;
xnext=x+pre_computed_skip_segment
   ynext=y
   znext=z
}else {
   skip_walk=false; }
if(skip_walk)
   skip walk through the WGs for pre_computed_skip_segment
      where num_clusters is the number of compute clusters assigned to the application 112 xdim is the length of the thread grid 115 along the X dimension, and segment size is the number of thread groups included in each segment of the thread grid 115.

In some implementations, the processor 100 is configurable to operate in different modes, including a cooperative mode, wherein compute clusters of the processor 101 execute the thread grid 115 cooperatively, and a non-cooperative mode, wherein each compute cluster of the processor 101 operates as a separate processing unit. In at least some of these implementations, the dispatch controllers 104-107 are configured to skip segments of the thread grid 115 in response to identifying (e.g., based on a register value or other configuration information) that the processor 101 is in the cooperative mode. In response to identifying that the processor 101 is in the non-cooperative mode, the dispatch controllers 104-107 select each segment of a received thread grid for dispatch.

An example of thread segment selection at the processor 101 is illustrated at FIG. 3 in accordance with some implementations. In particular, FIG. 3 illustrates an example of the dispatch controllers 104 and 105 selecting portions of the thread segments 125 and 126 along the X-axis of the thread grid 115. In the depicted example, the dispatch controller 104 selects an initial thread segment 350 of the thread grid 115 and dispatches the corresponding threads to the compute cluster 120 during the Nth processor cycle of the processor 101. The dispatch controller 104 then skips (that is, does not review) M segments of the thread grid, where M is the number of compute clusters assigned to the application 112, and selects the resulting segment 351. The dispatch controller 104 dispatches the threads of the selected segment during the N+1 processor cycle. Thus, the dispatch controller dispatches the segment 351 in the next processor cycle after dispatching the segment 350, rather than reviewing the segment 355 that is targeted to the compute cluster 121. The dispatch controller 104 thus increases dispatch throughput.

After selecting the segment 351, the dispatch controller 104 then skips another M segments, selects the segment 352, and dispatches the threads identified by segment 352 during the N+2 processor cycle. The dispatch controller 104 again skips M segments, selects the segment 353 and dispatches the threads identified by the segment 353 to the compute cluster 120 during the N+3 processor cycle. Thus, the dispatch controller 104 repeatedly skips M segments along the X dimension, until reaching the end of the thread grid along that dimension. The dispatch controller 104 then selects another segment along the Y dimension and repeats the skipping process.

Concurrently with the dispatch controller 104 dispatching the segments 350-353, the dispatch controller 105 dispatches a number of segments of the thread grid 115 to the compute cluster 121. In particular, during the Nth processor cycle, the dispatch controller 105 selects the segment 355 of the thread grid 115 and dispatches the indicated threads to the compute cluster 121. The dispatch controller 105 then skips M segments of the thread grid 115, selects the resulting segment 356, and dispatches the corresponding threads to the compute cluster 121 during the N+1 processor cycle. Next, the dispatch controller 105 again skips M segments of the thread grid 115, selects the resulting segment 357, and dispatches the corresponding threads to the compute cluster 121 during the N+2 processor cycle. The dispatch controller then skips M segments of the thread grid 115, selects the resulting segment 358, and dispatches the corresponding threads to the compute cluster 121 during the N+3 processor cycle. The dispatch controllers 106 and 107 similarly and concurrently select segments of the thread grid 115 by starting with a different initial segment and skipping M segments each cycle, and dispatch the selected segments to the compute clusters 122 and 123, respectively.

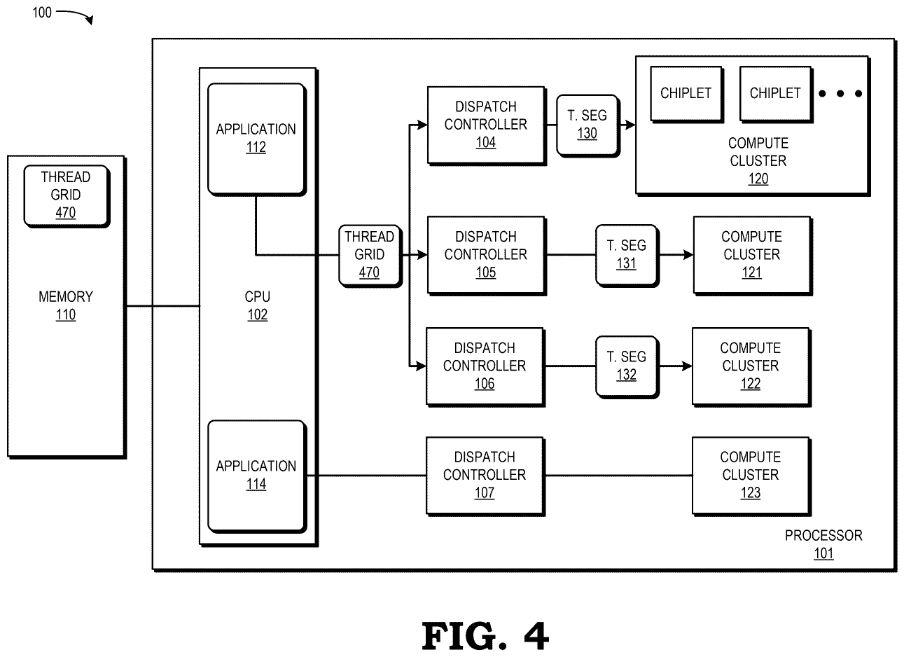

As noted above, in some implementations the processor 101 is configurable to allow for assignment of the compute clusters 120-123 to different applications (e.g., different virtual machines) at different times. In the example of FIG. 1, all of the compute clusters 120-23 are assigned to the same application 112. FIG. 4 illustrates a block diagram of a different configuration of the processor 101, wherein a hypervisor (not shown) has configured one or more registers of the processor 101 so that compute clusters 120-122 are assigned to the application 112 and the compute cluster 123 is assigned to an application 114. For example, in some implementations the compute clusters 120-122 together perform graphics operations, such that the application 112 interfaces with compute clusters 120-122 as if the clusters collectively form a single graphics processing unit. The compute cluster 123 also performs graphics operations, and the application 114 interfaces with the compute cluster 123 as a GPU.

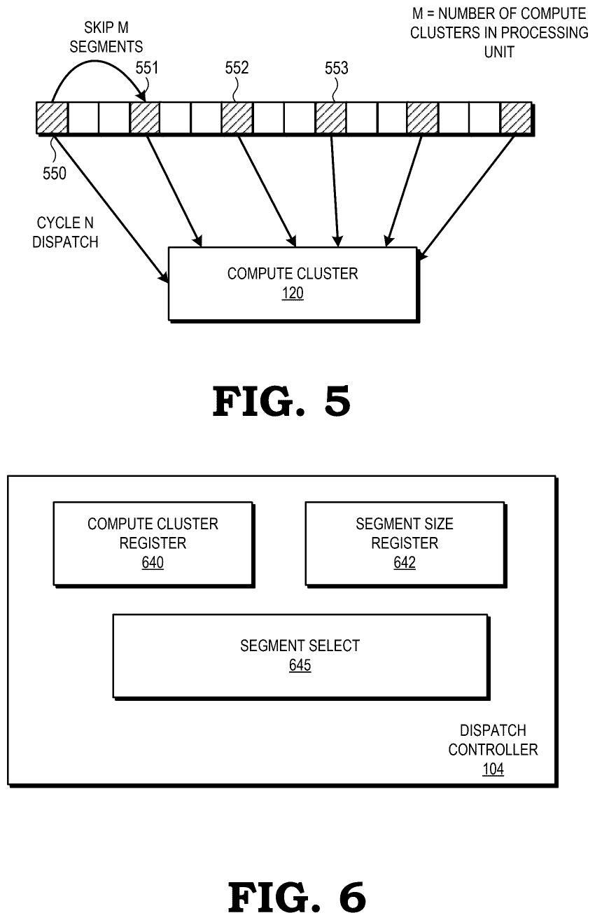

In the depicted implementation, the application 112 generates a thread grid 470 to distribute work among the compute clusters 120-122. The dispatch controllers 104-106 are configured to select threads from the thread grid 470 based on the number of compute clusters assigned to the application 112. An example is illustrated at FIG. 5 in accordance with some implementation. In the illustrated example, the dispatch controller 104 selects an initial thread segment 550 of the thread grid 115 and dispatches the corresponding threads to the compute cluster 120 during the Nth processor cycle of the processor 101. The dispatch controller 104 then skips (that is, does not review) M segments of the thread grid, where M is the number of compute clusters assigned to the application 112. In this case, M is three (in contrast to the configuration of FIG. 1, wherein M is four). The dispatch controller thus selects the resulting segment 551. The dispatch controller 104 dispatches the threads of the selected segment during the N+1 processor cycle. Thus, the dispatch controller dispatches the segment 351 in the next processor cycle after dispatching the segment 550. After selecting the segment 551, the dispatch controller 104 then skips another M segments, selects the segment 552, and dispatches the threads identified by segment 552 during the N+2 processor cycle. The dispatch controller 104 again skips M segments, selects the segment 553 and dispatches the threads identified by the segment 553 to the compute cluster 120 during the N+3 processor cycle. The dispatch controller continues to skip M segments to select the next segment, until reaching the end of the thread grid 470 along the X dimension and then proceeds along the Y dimension. Thus, as illustrated by the examples of FIGS. 4 and 5, the dispatch controllers 104-107 change how segments are selected from a thread grid according to the number of compute clusters assigned to an application.

FIG. 6 illustrates an example block diagram of the dispatch controller 104 in accordance with some implementation. In the depicted example, the dispatch controller 104 includes a compute cluster register 640, a segment size register 642, and segment select circuitry 645. The compute cluster register 640 stores a value indicating the number of compute clusters assigned to the application providing the thread grid to the dispatch controller 104. In some implementations, the value of the compute cluster register 640 is programmed by a hypervisor during a configuration process for the processing system 100. For example, when the number of compute clusters assigned to an application changes (e.g., because a new application has been initiated or because the system resources assigned to the application have been changed by the hypervisor), the hypervisor programs the compute cluster register with a value indicating the number of compute clusters assigned to the application.

The segment size register 642 stores a value indicating the number of thread groups represented by each segment of the thread grid provided to the dispatch controller 104. In some implementations, the segment size register 642 is programmable by the application generating the thread grid, to indicated how many thread groups are included in each segment. The segment select circuitry 645 is one or more circuits that collectively select segments from a thread grid as described herein. For example, in some implementations the segment select circuitry 645 is configured to determine a skip length by multiplying the value at the compute cluster register 640 with the value at the segment size register 642. The segment select circuitry 645 employs the skip length to determine the number of thread groups to skip along the X axis of the thread grid for one or more processor cycles.

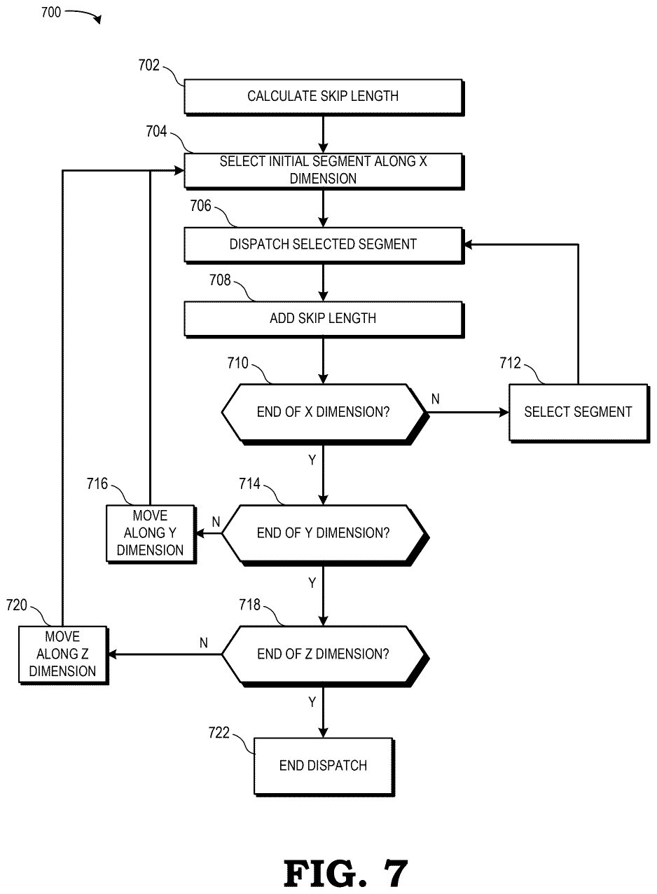

FIG. 7 illustrates a flow diagram of a method 700 of dispatching segments of a thread grid in accordance with some implementations. For purposes of description, the method 700 is described with respect to an example implementation at the processing system 100, but it will be appreciated that in other embodiments the method 700 is implemented at processors and processing systems having a different configuration. At block 702, the dispatch controller 104 receives the thread grid 115 and calculates, based on the values stored at the compute cluster register 640 and the segment size register 642, a skip length. For example, in some implementations the dispatch controller 104 determines the skip length by multiplying the number of compute clusters assigned to the application 112 and the number of thread groups for each segment of the thread grid 115. The dispatch controller 104 also initializes values for the X, Y, and Z dimensions of the thread grid 115 (e.g., by setting these values to zero).

At block 704, for the current X dimension value for the thread grid 115, the dispatch controller 104 identifies an initial segment along the X dimension. For example, in some implementations the dispatch controller 104 performs a grid walk, wherein the dispatch controller 104 starts at the first segment along the X dimension, and reviews each segment until the dispatch controller 104 reaches a segment that indicates the segment is targeted to the compute cluster 120. The dispatch controller 104 selects the identified initial segment and, at block 706, dispatches the thread groups identified by the selected segment to the compute cluster 120. In response, the compute cluster 120 executes the dispatched threads.

At block 708, the dispatch controller 104 adds the skip length to the current value for the X dimension. At block 710, the dispatch controller 104 determines whether the current value for the X dimension is past the end of the thread grid 115 along the X dimension. If not, the method flow moves to block 712 and the dispatch controller 104 selects the segment of the thread grid 115 indicated by the X dimension value, and then returns to block 706 where the dispatch controller 104 dispatches the thread groups indicated by the selected segment to the compute cluster 120. Thus, rather than reviewing each segment of the thread grid, the dispatch controller 104 skips segments along the X dimension, thereby improving dispatch throughput and overall processing efficiency at the processing system 100.

Returning to block 710, if the value of the X dimension is past the end of the thread grid 115, the method flow moves to block 714 and the dispatch controller 104 determines if the Y dimension value is at the maximum value—that is, if the Y dimension value is the highest Y dimension value for the thread grid 115. If not, the method proceeds to block 716 and the dispatch controller 104 moves along the Y dimension of the thread grid 115 by increasing (e.g., incrementing) the Y dimension value. The method flow returns to block 704 and the dispatch controller 104 again identifies an initial segment along the X dimension, with the new Y dimension value.

If, at block 714, the dispatch controller 104 determines that the Y dimension value is the highest Y dimension value for the thread grid 115, the method proceeds to block 718 and the dispatch controller 104 dimension is past the end of the thread grid 115, the method flow moves to block 714 and the dispatch controller 104 determines if the Z dimension value is at the maximum value—that is, if the Z dimension value is the highest Z dimension value for the thread grid 115. If not, the method proceeds to block 720 and the dispatch controller 104 moves along the Z dimension of the thread grid 115 by increasing (e.g., incrementing) the Z dimension value, and also resets the Y dimension value to the initial value. The method flow returns to block 704 and the dispatch controller 104 again identifies an initial segment along the X dimension, with the new Z dimension value. If, at block 718, the dispatch controller 104 determines that the Z dimension value is the highest Z dimension value for the thread grid 115, the method proceeds to block 722 and the dispatch of thread grid 115 completes.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
dispatching, during a first processor cycle, a first segment of a thread grid to a first compute cluster of a processor, the thread grid having a plurality of dimensions including a first dimension;
selecting, based on a programmable segment size, a second segment of the thread grid along the first dimension; and
dispatching, during a second processor cycle immediately following the first processor cycle, the second segment to the first compute cluster.

2. The method of claim 1, further comprising:
selecting, based on the programmable segment size, a third segment of the thread grid along the first dimension; and
dispatching, during a third processor cycle immediately following the second processor cycle, the third segment to the first compute cluster.

3. The method of claim 1, further comprising:
in response to selecting a first number of segments along the first dimension, selecting a third segment of the thread grid along a second dimension.

4. The method of claim 3, further comprising:
dispatching, during the first processor cycle, a third segment of the thread grid to a second compute cluster of the processor.

5. The method of claim 4, further comprising:
selecting, based on the programmable segment size, a fourth segment of the thread grid along the first dimension; and
dispatching, during the second processor cycle, the fourth segment to the first compute cluster.

6. The method of claim 1, wherein selecting the second segment comprises selecting the second segment in response to processor being in a cooperative mode to execute the thread grid cooperatively at multiple compute clusters.

7. The method of claim 1, wherein selecting the second segment comprises selecting the second segment based on a number of compute clusters at the processor.

8. The method of claim 7, wherein the number of compute clusters at the processor is configurable.

9. A processor, comprising:
a first compute cluster; and
a first dispatch controller configured to:
dispatch, during a first processor cycle, a first segment of a thread grid to the first compute cluster, the thread grid having a plurality of dimensions including a first dimension;
select, based on a programmable segment size, a second segment of the thread grid along the first dimension; and
dispatch, during a second processor cycle immediately following the first processor cycle, the second segment to the first compute cluster.

10. The processor of claim 9, wherein the first dispatch controller is configured to:
select, based on the programmable segment size, a third segment of the thread grid along the first dimension; and
dispatch, during a third processor cycle immediately following the second processor cycle, the third segment to the first compute cluster.

11. The processor of claim 9, wherein the first dispatch controller is configured to:
in response to selecting a first number of segments along the first dimension, select a third segment of the thread grid along a second dimension.

12. The processor of claim 11, further comprising:
a second compute cluster; and
a second dispatch controller configured to:
dispatch, during the first processor cycle, a third segment of the thread grid to the second compute cluster.

13. The processor of claim 12, wherein the second dispatch controller is configured to:
select, based on the programmable segment size, a fourth segment of the thread grid along the first dimension; and
dispatch, during the second processor cycle, the fourth segment to the first compute cluster.

14. The processor of claim 9, wherein the first dispatch controller is configured to select the second segment comprises in response to the processor being in a cooperative mode to execute the thread grid cooperatively at multiple compute clusters.

15. The processor of claim 9, wherein the first dispatch controller is configured to select the second segment based on a number of compute clusters at the processor.

16. The processor of claim 15, wherein the number of compute clusters at the processor is configurable.

17. A processing system, comprising:
a memory configured to store a thread grid for an application; and
a processor, comprising
a first compute cluster; and
a first dispatch controller configured to:
dispatch, during a first processor cycle, a first segment of a thread grid to the first compute cluster, the thread grid having a plurality of dimensions including a first dimension;
select, based on a programmable segment size, a second segment of the thread grid along the first dimension; and
dispatch, during a second processor cycle immediately following the first processor cycle, the second segment to the first compute cluster.

18. The processing system of claim 17, wherein the first dispatch controller is configured to:
select, based on the programmable segment size, a third segment of the thread grid along the first dimension; and
dispatch, during a third processor cycle immediately following the second processor cycle, the third segment to the first compute cluster.

19. The processing system of claim 17, wherein the first dispatch controller is configured to:
in response to selecting a first number of segments along the first dimension, select a third segment of the thread grid along a second dimension.

20. The processing system of claim 19, wherein the processor further comprises:
a second compute cluster; and
a second dispatch controller configured to:
dispatch, during the first processor cycle, a third segment of the thread grid to the second compute cluster.
